(19) United States
(12) Patent Application Publication
(10) Pub. No.: US 2018/0227276 A1
(43) Pub. Date: Aug. 9, 2018

(54) DATA INTERACTION METHOD AND DEVICE FOR COMPOSITE SMART CARD DEVICE

(71) Applicant: SHENZHEN EXCELSECU DATA TECHNOLOGY CO.,LTD., Shenzhen, Guangdong (CN)

(72) Inventor: Liuzhang Chen, Shenzhen, Guangdong (CN)

(21) Appl. No.: 15/750,270

(22) PCT Filed: Dec. 8, 2015
(86) PCT No.: PCT/CN2015/096651

§ 371 Date: Feb. 5, 2018

(30) Foreign Application Priority Data
Aug. 6, 2015 (CN) 201510479160.3

(51) Int. Cl. H04L 29/06; H04W 76/10

(52) U.S. Cl. CPC H04L 63/0435; H04W 4/80; G06F 2213/0042; H04W 76/10

(57) ABSTRACT

The present application discloses a data interaction method and a data interaction device for a composite smart card device, in which, the composite smart card device includes a smart card and a U-shield in a communication connection with the smart card. The data interaction method includes: establishing a communication connection between the smart card and the terminal via the U-shield; and establishing a data security channel between the composite smart card device and a background server via the terminal to enable data interaction between the composite smart card device and the background server through the data security channel, in which, the data transmitted by the data security channel are all encrypted. Technical solutions provided by the present application can effectively improve the security of the data interaction in smart card applications.

### TECHNICAL FIELD

The present application relates to the communication field, and more particularly to a data interaction method and a data interaction device for a composite smart card device.

### BACKGROUND

A smart card is a card in which a microelectonic chip is embedded into a card matrix, due to its advantages of inherent information security, convenience portability, and relatively complete standardization, etc., the smart card has been more and more widely applied in fields such as ID authentication, banking, telecommunication, public transportation, and parking management. For example, UnionPay cards, social security cards, purchase secure access module (PSAM) cards, and so on, play important roles in people's daily lives.

For the current popular smart cards, data transactions (such as recharging of a smart card or reading and writing of other sensitive information) between a smart card and a terminal (or a server) adopt clear text transmission, the information is therefore prone to be stolen, and transaction security cannot be reliably ensured.

### SUMMARY

The present application provides a data interaction method and a data interaction device for a composite smart card device so as to improve the security of data interaction in smart card applications.

A first aspect of the present application provides a data interaction method for a composite smart card device. The composite smart card device comprises: a smart card and a U-shield in a communication connection with the smart card; the data interaction method comprises:

establishing a communication connection between the smart card and the terminal via the U-shield; and

establishing a data security channel between the composite smart card device and a background server via the terminal to enable data interaction between the composite smart card device and the background server through the data security channel, in which, the data transmitted by the data security channel are all encrypted.

A second aspect of the present application provides a data interaction device for a composite smart card device. The composite smart card device comprises a smart card and a U-shield in a communication connection with the smart card; the data interaction device comprises:

a communication-connection establishing unit, configured to establish a communication connection between the smart card and the terminal via the U-shield; and

a data-security-channel establishing unit, configured to establish a data security channel between the composite smart card device and a background server via the terminal to enable data interaction between the composite smart card device and the background server through the data security channel, in which, the data transmitted by the data security channel are all encrypted.

It is known from the above description that in this application, the communication connection between the smart card of the composite smart card device and the terminal is established by the U-shield of the composite smart card device, and the data security channel between the composite smart card device and the background server is established by the terminal, such that the data interaction is performed between the composite smart card device and the background server via the data security channel. Because encrypted transmission of the data interaction in the data security channel is realized, the data interaction between the composite smart card device and the background server can be prevented from being stolen, thereby improving the security of the data transmission and further improving the security of the data interaction in the smart card applications.

### BRIEF DESCRIPTION OF THE DRAWINGS

In order to more clearly illustrate the technical solution in embodiments of the present application, the following drawings, which are to be used in the description of the embodiments or the prior art, will be briefly described. It will be apparent that the drawings described in the following description are merely embodiments of the present application. Other drawings may be obtained by those skilled in the art without paying creative labor.

FIG. 1 is a schematic flow chart of one embodiment of a data interaction method for a composite smart card device provided by the present application;

FIG. 2 is a structural schematic diagram of one embodiment of a composite smart card device provided by the present application;

FIG. 3 is a structural schematic diagram of another embodiment of the composite smart card device provided by the present application;

FIG. 4 is a schematic diagram of data transmission channel connection between a composite smart card device provided by the present application and a background server; and

FIG. 5 is structural schematic diagram of one embodiment of a data interaction device provided by the present application.

### DETAILED DESCRIPTION OF THE EMBODIMENTS

In order to make the objects, features, and advantages of the present application clearer and easier to be understood, technical solutions in embodiments of the present application are clearly and integrally described hereinbelow with reference to accompanying drawings in the embodiments of the present application. Obviously, the described embodiments are only a part of embodiments of the present application, rather than all the embodiments. All other embodiments obtained by a person of ordinary skill in the art based on the embodiments of the present application without creative efforts shall fall within the protection scope of the present application.

A data interaction method for a composite smart card device is provided by an embodiment of the present application. The composite smart card device comprises: a smart card and a U-shield in a communication connection with the smart card. The data interaction method comprises: establishing a communication connection between the smart card and the terminal via the U-shield; establishing a data security channel between the composite smart card device and a background server via the terminal to enable data interaction between the composite smart card device and the background server through the data security channel, in which, the data transmitted by the data security channel are all encrypted. The data interaction device is also provided by this embodiment of the present application and is respectively described in detail below.

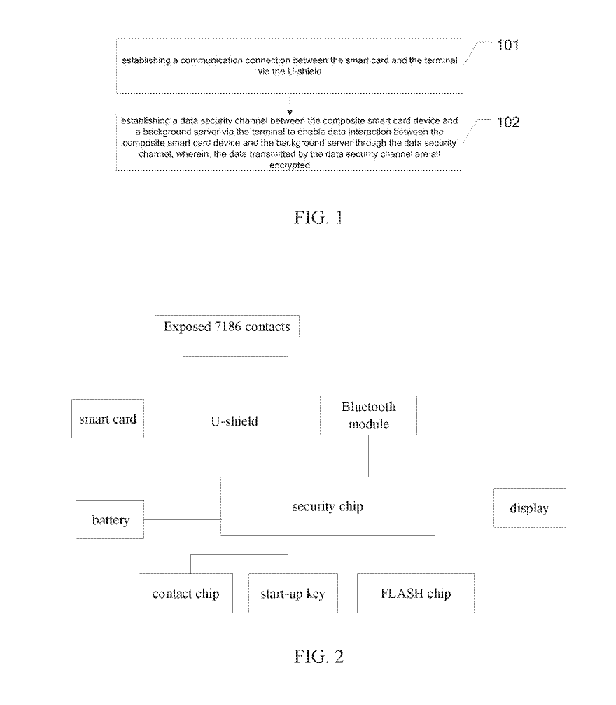

The data interaction method for the composite smart card device provided by the embodiment of the present application is described hereinbelow, please refer to FIG. 1, the data interaction method in this embodiment of the present application comprises:

101. establishing communication connection between the smart card of the composite smart card device and the terminal via the U-shield of the composite smart card device;

In this embodiment of the present application, the composite smart card device comprises: the smart card and the U-shield in a communication connection with the smart card. The smart card in this embodiment of the present application can be a contact card or dual-interface card, specifically, the communication connection between the smart card and the U-shield in the composite smart card device can be realized via a contact connection manner.

In this embodiment of the present application, the data interaction device establishes the communication connection between the smart card of the composite smart card device and the terminal via the U-shield of the composite smart card device.

Alternatively, the U-shield comprises a universal serial bus (USB) interface, the data interaction device can use the U-shield as a USBkey, communication connection between the U-shield and the terminal is established based on a USB protocol, because the smart card is in communication connection with the U-shield, when the communication connection between the U-shield and the terminal is established based on the USB protocol, the communication connection between the smart card and the terminal is realized. Or, the composite smart card device may comprises a Bluetooth module, and the data interaction device can use the U-shield as a Bluetooth shield, and the communication connection between the U-shield and the terminal is established based on a Bluetooth protocol, similarly, when the communication connection between the U-shield and the terminal is established based on the Bluetooth protocol, the communication connection between the smart card and the terminal can be realized. It can be understood that the data interaction device can adopt the U-shield and other protocols to establish the communication connection between the U-shield and the terminal, for example, the U-shield acts as an audio shield, and the communication connection between the U-shield and the terminal is established based on the audio shield. The protocols are not limited herein.

Alternatively, as shown in FIG. 2, the composite smart card device in this embodiment of the present application is provided internally with one security chip which is used by the U-shield and the smart card, in addition, the composite smart card device further comprises a Bluetooth module configured to provide a Bluetooth communication, a contact chip configured to provide a contact key function, a battery configured to supply power, a display configured to provide a user interface, a start-up key, a FLASH chip, etc. As shown in FIG. 2, the composite smart card device further comprises exposed ISO/IEC 7816 contacts, and the smart card and the U-shield share the ISO/IEC 7816 contacts as a power supply input, when the composite smart card device is inserted into a smart card reader, the ISO/IEC 7816 contacts acts as ISO/IEC 7816 communication, when the composite smart card device is inserted into a personal computer (PC) or an USB interface of other terminals, the ISO/IEC 7816 contacts acts as USB communication. The U-shield and the smart card can communicate according to the standard 7816 communication protocol. It can be understood that the composite smart card device may also be provided internally with two security chips, which are respectively used by the smart card and the U-shield.

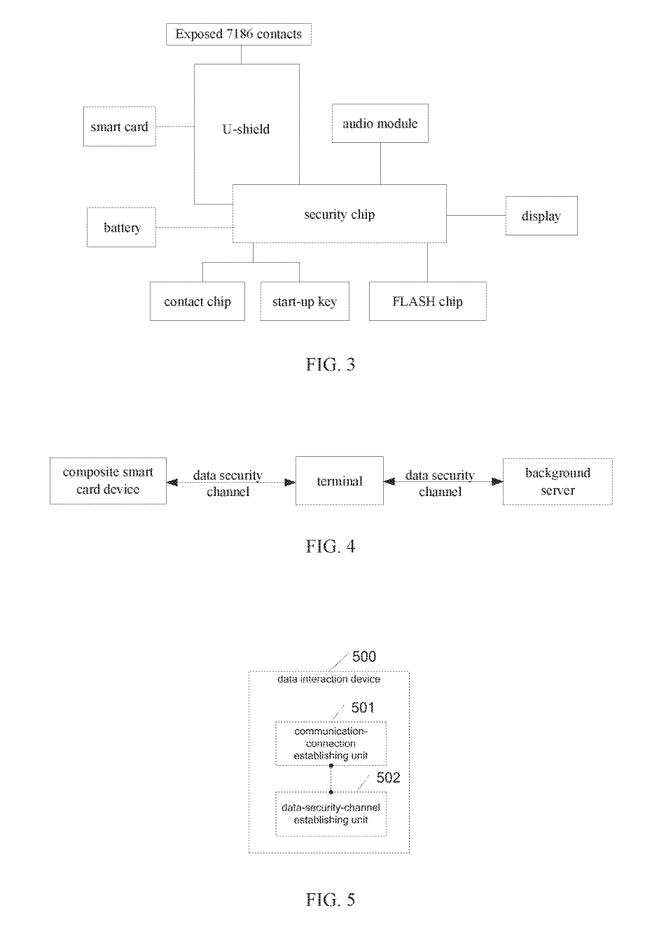

Alternatively, as shown in FIG. 3, the composite smart card device in this embodiment of the present application is provided internally with one security chip which is used by the U-shield and the smart card, in addition, the composite smart card device further comprises an audio module configured to provide an audio communication, a contact chip configured to provide a contact key function, a battery configured to supply power, a display configured to provide a user interface, a start-up key, a FLASH chip, etc. As shown in FIG. 3, the composite smart card device further comprises exposed ISO/IEC 7816 contacts, and the smart card and the U-shield share the ISO/IEC 7816 contacts as a power supply input, when the composite smart card device is inserted into a smart card reader, the ISO/IEC 7816 contacts acts as the ISO/IEC 7816 communication, when the composite smart card device is inserted into a personal computer (PC) or an USB interface of other terminals, the ISO/IEC 7816 contacts acts as the USB communication. The U-shield and the smart card can communicate according to the standard 7816 communication protocol. It can be understood that the composite smart card device may also be provided internally with two security chips, which are respectively used by the smart card and the U-shield.

It can be understood that the composite smart card device in this embodiment of the present application may also be formed by other modules, and a specific structure of the composite smart card device is not limited in the present application.

Specifically, the smart card in this embodiment of the present application may be a UnionPay card, a social security card, a terminal PSAM card, etc., which are not limited herein.

102. establishing the data security channel between the composite smart card device and the background server via the terminal to enable data interaction between the composite smart card device and the background server through the data security channel.

in which, the data transmitted by the data security channel are all encrypted.

Alternatively, after the communication connection between the smart card of the composite smart card device and the terminal is established, the data interaction device negotiates a symmetric key with the background server through the terminal and determines the symmetric key as an encrypted key used by the data security channel. Specifically, after the communication connection between the composite smart card device and the terminal is established, the data interaction device generates the symmetric key by a symmetric algorithm and transmits the symmetric key to the background server via the terminal, so as to instruct the background server to use the symmetric key to encrypt the transmission data when transmitting data to the composite smart card device via the terminal, meanwhile, when the smart card transmits data to the background server via the terminal, the data interaction device uses the symmetric key to encrypt the transmission data.

It should be understood that other kinds of encrypted keys may also be used by this embodiment of the present application to establish the data security channel, as long as the encrypted keys comply with the algorithm requirement of the state encryption administration.

Alternatively, when it is determined that the communication connection between the smart card of the composite smart card device and the terminal is successfully established, it is detected by the data interaction device whether the background server performs a sensitive information transaction (such as recharge, cash withdrawal, etc.) on the smart card, and only when it is determined by the data interaction device that the terminal is performing the sensitive information transaction on the smart card, execution of step 102 is triggered.

Specifically, a structural diagram of connection of a data transmission channel between the composite smart card device and the background server is shown in FIG. 4, it should be noted that in the structural diagram of the connection of the data transmission channel in FIG. 4, the terminal only forwards the data interaction between the composite smart card device and the background server rather than processes the data.

It should be noted that the data interaction device in this embodiment of the present application is integrated into the composite smart card device, and the terminal in this embodiment of the present application may specifically be a smart card reader, a notebook computer, a tablet computer, or other types of terminals, which are not limited herein.

It can be known from the above description that in this application, the communication connection between the smart card of the composite smart card device and the terminal is established by the U-shield of the composite smart card device, and the data security channel between the composite smart card device and the background server is established by the terminal, such that the data interaction is performed between the composite smart card device and the background server via the data security channel, because encrypted transmission of the data interaction in the data security channel is realized, the data interaction between the composite smart card device and the background server can be prevented from being stolen, thereby improving the security of the data transmission and further improving the security of the data interaction in the smart card applications.

A data interaction device for a composite smart card device in another embodiment of the present application is described hereinbelow, in which, the composite smart card device comprises a smart card and a U-shield in a communication connection with the smart card, a specific structure of the composite smart card device can refer to the composite smart card device as shown in the embodiment of FIG. 2 or FIG. 3. Please refer to FIG. 5, the data interaction device 500 in this embodiment of the present application comprises:

a communication-connection establishing unit 501, configured to establish a communication connection between the smart card and the terminal via the U-shield;

a data-security-channel establishing unit 502, configured to establish a data security channel between the composite smart card device and a background server via the terminal to enable data interaction between the composite smart card device and the background server through the data security channel, in which, the data transmitted by the data security channel are all encrypted.

Alternatively, the data-security-channel establishing unit 502 comprises: a negotiation unit configured to negotiate a symmetric key with the background server via the terminal; and a determination unit configured to determine the symmetric key as an encrypted key used by the data security channel.

Alternatively, the U-shield comprises an USB interface; and the communication-connection establishing unit 501 is specifically configured to establish a communication connection between the U-shield and the terminal based on a USB protocol.

Alternatively, the composite smart card device in this embodiment of the present application comprises a Bluetooth module; and the communication-connection establishing unit 501 is specifically configured to establish the communication connection between the U-shield and the terminal based on a Bluetooth protocol.

Alternatively, the data-security-channel establishing unit 502 is specifically configured to establish the data security channel between the composite smart card device and the background server via the terminal when it is determined that the communication connection between the smart card and the terminal is successfully established and that the background servers performs a sensitive information transaction on the smart card.

It should be noted that the data interaction device in this embodiment of the present application is integrated into the composite smart card device, the terminal in this embodiment of the present application can specifically be a smart card reader, a notebook computer, a tablet computer, or other types of terminals, which are not limited herein.

It should be understood that the data interaction device in this embodiment of the present application and the data interaction device in the above method embodiment of the present application can be used to realize all the technical solutions of the above method embodiment, functions of each functional module can be specifically implemented according to the method of the above method embodiment, and the specific implementation can refer to related description of the above embodiment and will not repeated herein.

It can be known from the above description that in this application, the communication connection between the smart card of the composite smart card device and the terminal is established by the U-shield of the composite smart card device, and the data security channel between the composite smart card device and the background server is established by the terminal, such that the data interaction is performed between the composite smart card device and the background server via the data security channel, because encrypted transmission of the data interaction in the data security channel is realized, the data interaction between the composite smart card device and the background server can be prevented from being stolen, thereby improving the security of the data transmission and further improving the security of the data interaction in the smart card applications.

It should be understood that the systems, apparatuses and methods disclosed in some embodiments provided by the present application can also be realized in other ways. For example, the described apparatus embodiments are merely schematic; for example, the division of the units is merely a division based on logic function, whereas the units can be divided in other ways in actual realization; for example, a plurality of units or components can be grouped or integrated into another system, or some features can be omitted or not executed. Furthermore, the shown or discussed mutual coupling or direct coupling or communication connection can be achieved by indirect coupling or communication connection of some interfaces, apparatuses or units in electric, mechanical or other ways.

The units described as isolated elements can be or not be separated physically; an element shown as a unit can be or not be physical unit, which means that the element can be located in one location or distributed at multiple network units. Some or all of the units can be selected according to actual needs to achieve the purpose of the schemes of the embodiments.

Furthermore, each functional unit in each embodiment of the present application can be integrated into a processing unit, or each unit can exist in isolation, or two or more than two units can be integrated into one unit.

If the integrated unit is achieved in software functional unit and sold or used as an independent product, the integrated unit can be stored in a computer-readable storage medium. Based on this consideration, the substantial part, or the part that is contributed to the prior art of the technical solution of the present application, or part or all of the technical solutions can be embodied in a software product. The computer software product is stored in a storage medium, and includes several instructions configured to enable a computer device (can be a personal computer, device, network device, and so on) to execute all or some of the steps of the method of each embodiment of the present application. The storage medium includes a U disk, a mobile hard disk, a read-only memory (ROM), a random access memory (RAM), a disk or a light disk, and other various media which can store program codes.

It should be noted that, the aforementioned method embodiments are described as a combination of a series of actions for facilitating the description, however, those skilled in the art should understand that the present application is not limited by the order of the described actions, because according to the present application, some steps can adopts other orders or be executed synchronously. Moreover, those skilled in the art should understand that the embodiments described in the specification are preferred embodiments, and the actions and the modules involved therein are not necessarily essential to the present application.

In the above embodiments, the description of different embodiments focus on different parts, for those parts that are not described in detail in some embodiments, related description in other embodiments can be referred to.

The data interaction method and device for the composite smart card device provided by the present application are described in the above. For persons of ordinary skills in the art, according to the spirit of the embodiments of the present application, the specific embodiments and application range can vary, therefore, the contents of the specification should not be construed as a limitation of the present application.

1. A data interaction method for a composite smart card device, wherein the composite smart card device comprises: a smart card and a U-shield in a communication connection with the smart card; the data interaction method comprises:
establishing a communication connection between the smart card and the terminal via the U-shield; and
establishing a data security channel between the composite smart card device and a background server via the terminal, to enable data interaction between the composite smart card device and the background server through the data security channel, wherein the data transmitted by the data security channel are all encrypted.

2. The method of claim 1, wherein the step of establishing a data security channel between the composite smart card device and a background server via the terminal comprises:
negotiating a symmetric key with the background server via the terminal; and
determining the symmetric key as an encrypted key applicable to the data security channel.

3. The method of claim 1, wherein
the U-shield comprises a universal serial bus interface; and
the step of establishing the communication connection between the smart card and the terminal via the U-shield comprises:
establishing the communication connection between the U-shield and the terminal based on a universal serial bus protocol.

4. The method of claim 1, wherein
the composite smart card device comprises a Bluetooth module; and
the step of establishing the communication connection between the smart card and the terminal via the U-shield comprises:
establishing the communication connection between the U-shield and the terminal based on a Bluetooth protocol.

5. The method of claim 1, wherein
the composite smart card device comprises an audio module; and
the step of establishing the communication connection between the smart card and the terminal via the U-shield comprises:
establishing the communication connection between the U-shield and the terminal based on an audio protocol.

6. The method of claim 1, wherein the step of establishing a data security channel between the composite smart card device and a background server via the terminal comprises:
establishing the data security channel between the composite smart card device and the background server via the terminal when it is determined that the communication connection between the smart card and the terminal is successfully established and that the background server performs sensitive information transaction on the smart card.

7. A data interaction device for a composite smart card device, wherein the composite smart card device comprises a smart card and a U-shield in a communication connection with the smart card; the data interaction device comprises:
a communication-connection establishing unit, configured to establish a communication connection between the smart card and the terminal via the U-shield; and
a data-security-channel establishing unit, configured to establish a data security channel between the composite smart card device and a background server via the terminal, to enable data interaction between the composite smart card device and the background server through the data security channel, wherein the data transmitted by the data security channel are all encrypted.

8. The device of claim 7, wherein the data-security-channel establishing unit comprises:
a negotiation unit configured to negotiate a symmetric key with the background server via the terminal; and
a determination unit configured to determine the symmetric key as an encrypted key applicable to the data security channel.

9. The device of claim 7, wherein the U-shield comprises a universal serial bus interface; and
the communication-connection establishing unit is configured to establish a communication connection between the U-shield and the terminal based on a universal serial bus protocol.

10. The device of claim 7, wherein
the composite smart card device comprises a Bluetooth module; and
the communication-connection establishing unit is configured to establish communication connection between the U-shield and the terminal based on a Bluetooth protocol.

11. The device of claim 7, wherein
the composite smart card device comprises an audio module; and
the communication-connection establishing unit is configured to establish communication connection between the U-shield and the terminal based on an audio protocol.

12. The device of claim 7, wherein the data-security-channel establishing unit is configured to:
establish the data security channel between the composite smart card device and the background server via the terminal when it is determined that the communication connection between the smart card and the terminal is successfully established and that the background server performs a sensitive information transaction on the smart card.
